(19) United States
(12) Patent Application Publication
(10) Pub. No.: US 2026/0057580 A1
(43) Pub. Date: Feb. 26, 2026

(54) AI-BASED PHOTO DESIGN IDEA GENERATION AND IMPLEMENTATION

(71) Applicant: Microsoft Technology Licensing, LLC, Redmond, WA (US)

(72) Inventors: Jaimin Ajay PATEL, Seattle, WA (US); Srinivasa Chaitanya Kumar Reddy GOPIREDDY, Bothell, WA (US); Adhiraj SOOD, Bothell, WA (US); David Felipe CASTILLO VELAZQUEZ, Redmond, WA (US)

(73) Assignee: Microsoft Technology Licensing, LLC, Redmond, WA (US)

(21) Appl. No.: 18/815,396

(22) Filed: Aug. 26, 2024

(51) Int. Cl. G06T 11/60

(52) U.S. Cl. CPC G06T 11/60; G06T 2211/441

(57) ABSTRACT

A data processing system implements capturing, via a user interface of a client device, a photo; generating one or more photo design suggestion images using an artificial intelligence (AI) model based on metadata of the photo by inserting at least one first foreground object, extracting text from the metadata as a portion of a prompt, or a combination thereof, wherein the metadata includes a location, a time, and one or more image tags; and providing the one or more photo design suggestion images to display on the user interface of the client device.

### BACKGROUND

Artificial intelligence (AI) has the potential to automate our lives to save time and increase productivity. One area of interest is photography, and AI-based photo capturing and editing tools have become popular. Some existing AI-based photo capturing platforms or applications analyze a scene for photography, and automatically adjust camera settings like exposure, focus, and white balance for optimal results. Other AI-based photo capturing tools display lines or grids on a camera screen to guide a user to take a more balanced shot. However, it is up to the user to pick a scene to photo. Yet, it is time-consuming for the user to browse online for photoshoot ideas, to find desirable scenes, to locate a physical shooting location for a desired scene, and then manually adjust a camera to take a photo of the desired scene. There are technical challenges to provide users with automated photoshoot ideas and easy-to-implement photoshoot mechanisms. Hence, there is a need for AI-based photoshoot idea generation and implementation systems and methods.

### SUMMARY

An example data processing system according to the disclosure includes a processor and a machine-readable medium storing executable instructions. The instructions when executed cause the processor alone or in combination with other processors to perform operations including capturing, via a user interface of a client device, a photo; generating one or more photo design suggestion images using an artificial intelligence (AI) model based on metadata of the photo by inserting at least one first foreground object, extracting text from the metadata as a portion of a prompt, or a combination thereof, wherein the metadata includes a location, a time, and one or more image tags; and providing the one or more photo design suggestion images to display on the user interface of the client device.

An example method implemented in a data processing system includes capturing, via a user interface of a client device, a photo; generating one or more photo design suggestion images using an artificial intelligence (AI) model based on metadata of the photo by inserting at least one first foreground object, extracting text from the metadata as a portion of a prompt, or a combination thereof, wherein the metadata includes a location, a time, and one or more image tags; and providing the one or more photo design suggestion images to display on the user interface of the client device.

An example non-transitory computer readable medium data processing system according to the disclosure on which are stored instructions that, when executed, cause a programmable device to perform functions of capturing, via a user interface of a client device, a photo; generating one or more photo design suggestion images using an artificial intelligence (AI) model based on metadata of the photo by inserting at least one first foreground object, extracting text from the metadata as a portion of a prompt, or a combination thereof, wherein the metadata includes a location, a time, and one or more image tags; and providing the one or more photo design suggestion images to display on the user interface of the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for AI-based photo design idea generation and implementation are implemented.

FIG. 2 is a conceptual diagram of a photo design idea generation and implementation pipeline of the system of FIG. 1 according to principles described herein.

FIGS. 3A-3E are diagrams of example user interfaces of an AI-based photo design idea generation and implementation application that implements the techniques described herein.

FIG. 4 depicts a flow chart of an example process for AI-based photo design idea generation and implementation according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for AI-based photo design idea generation and implementation are described herein. These techniques provide a technical solution to the technical problem of lack of easier-to-use AI-based photo design idea generation and implementation platforms/systems. A novel AI-based photo design idea generation and implementation pipeline improves efficiency and photo quality over the existing photo generation methods/systems by applying an AI model to generate photo design ideas/images. The existing photography planning applications find the positions of the sun or moon, calculate a depth of field, and scout locations and time points to take desired shots. Although these applications help users to plan photoshoots ahead of time to ensure the users present at the right place at the right time to capture the planned photos, it takes a long time and computer resources for a user to create and execute a photoshoot plan.

To address these issues, the proposed technical solution improves photo design idea generation and implementation using generative model(s) by providing users with AI-based photo design idea generation and implementations based on a novel photo design idea generation and implementation pipeline to streamline the user experience by eliminating the need for online researching and saving photo design ideas as templates, as well as by navigating a user to a location associated with a selected photo design idea. The pipeline enables users to take photos with desired scenes in the vicinity by simply uploading one user-captured photo taken onsite.

For example, the pipeline applies an AI model (based on e.g., machine learning or generative AI) to generate photo design ideas/images by extracting a subject of interest from a user-captured photo, and blending the subject into different backgrounds in the proximity based on the metadata (e.g., location, time, image tags, and the like) of the user-captured photo. Alternatively, the pipeline calls a text-to-image generative model to generate photo design ideas/images based on the metadata of the user-captured photo.

In one embodiment, the pipeline provides users with photo design suggestions based on metadata of a photo being captured or having been captured. The concept of the automatic suggestion includes generating photoshoot images including object(s) (e.g., salient objects, such as humans, faces, and the like in foreground) with different blended backgrounds behind the same object(s).

A technical benefit of the approach provided herein is to perform AI-based photo design idea generation through generative models and other tools within a design platform to increase user convenience by allowing a user to capture only a photo to automatically generate photo design suggestion images thus simplifying the photography process for the users and conserving computer resources. The photo design suggestion images promote intentional photography, and a specific photo design suggestion image moves the user beyond just point-and-shoot photography. In addition, the photo design suggestion images spark creativity, and help the user see different perspectives. As such, the user is more likely to capture interesting and creative photos.

Another technical benefit of the approach provided herein is to automate the AI-based photo design idea generation process, thereby eliminating the user having to manually select template images. This solution makes the photo-capturing process more productive for users. This case-of-use increases user productivity and utilization, as well as attracting more non-technical users.

Another technical benefit of the approach provided herein is to extract foreground object(s) from a user-captured photo, and then blend the foreground object(s) into template images as photo design suggestion images. This helps the user to visualize the foreground object(s) in the template images and makes photography more engaging.

Another technical benefit of the approach provided herein is to assist the user to capture a photo resembling a selected photo design suggestion image by navigating the user to the relevant location, and suggesting and/or automatically adjusting the relevant photoshoot camera settings. This significantly increases the user's chances of capturing a desired photo. Additionally, the displayed photoshoot camera settings can be applied by the user and gradually improve the user's photography skills.

An additional technical benefit of this approach is to provide automated AI-based photo design idea generation that offers more user choices/ideas, thereby improving the user experience.

Another technical benefit of this approach is storing the photo design suggestion images as template images in a visual content library thereby saving the user significant time and effort in creating similar photos in the future.

Yet, another technical benefit of this approach is to apply the AI-based photo design idea generation to a range of visual content types, including images, videos, or the like, which can be instrumental in photo creation, thereby enhancing the versatility of a design platform. These and other technical benefits of the techniques disclosed herein will be evident from the discussion of the example implementations that follow.

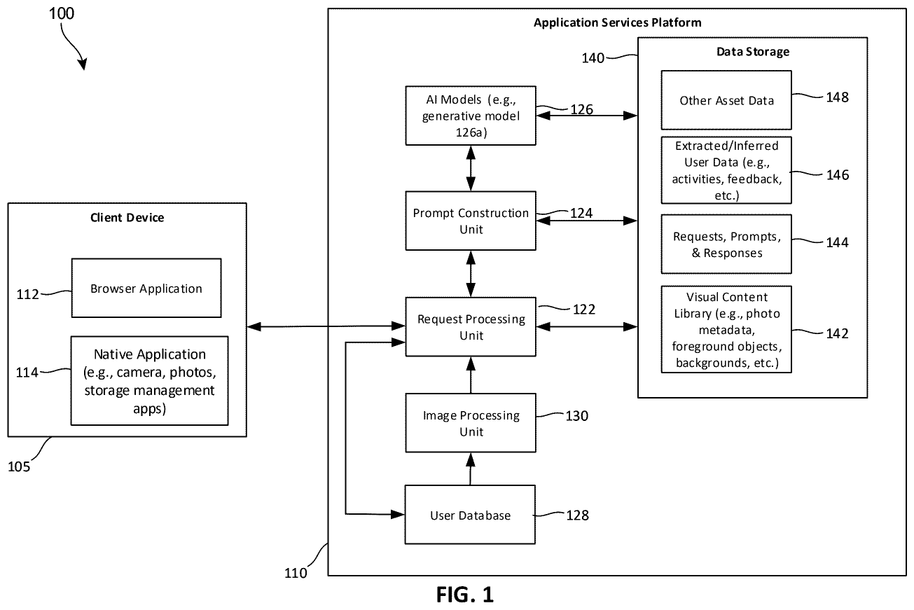

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to AI-based photography applications, camera application, photos applications, file management applications, presentation applications, website authoring applications, collaboration platforms, communications platforms, and/or other types of applications in which users may capture, view, and/or modify various types of photos. In the implementation shown in FIG. 1, the application services platform 110 applies generative AI to easily generate fast and satisfactory photo design suggestion images upon user demand, according to the techniques described herein. The client device 105 and the application services platform 110 communicate with each other over a network (not shown). The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

The term “photo design suggestion image” refers to a human visible content item that can assist a user to capture a photo. Common forms of visual content items include photos, diagrams, charts, images, infographics, videos, animations, screenshots, memes, slide decks, pictograms, ideograms, gaming interfaces, software application backgrounds, graphic designs (e.g., publication, email marketing templates, presentations, menus, social media ads, banners and graphics, marketing and advertising, packaging, visual identity, art and illustration graphic design, and the like), etc.

Although various embodiments are described with respect to photoshoots or photo design ideas, it is contemplated that the approach described herein may be used with any location-based videography, animation, motion graphics, user interface graphic design (e.g., game interface, app design, etc.), presentations, menus, social media ads, banners and graphics, marketing and advertising, packaging, visual identity, art and illustration graphic design, and the like.

The client device 105 includes a native application 114 and a browser application 112. The native application 114 is a native application, in some implementations, which enables easy AI-based photo design idea generation. The native application utilizes services provided by the application services platform 110 including but not limited to creating, viewing, and/or modifying various types of AI-based photo design ideas. For instance, the native application 114 can be a camera application, a photos application, or a storage management application (e.g., OneDrive Mobile®). The camera application saves the photo file to the client device storage, such as a designated folder like a Digital Camera Images (DCIM) folder, or a custom location depending on the client device model or camera application settings. The photos application continuously scans the client device storage for new files, including photos. When a new photo is detected in the designated location (e.g., DCIM), the photos application creates a thumbnail image for faster preview. The photos application displays the thumbnails it created, allowing a user to browse the photo collection easily. The photos application may extract additional information from the photo file (e.g., exchangeable image file format (EXIF) data) such as the date and time taken for better organization, and camera settings for photoshoot analysis. Camera settings can include camera model and make, aperture, shutter speed, ISO speed, focal length, white balance, and the like.

In one implementation, the storage management application interacts with a camera application and a photos application of the client device 105 to automatically or on demand upload new photos and videos captured by the camera application to a local and/or cloud storage. In another implementation, the storage management application is integrated with the camera application and/or the photos application for backing up photos/videos, to be accessible from any device with internet access.

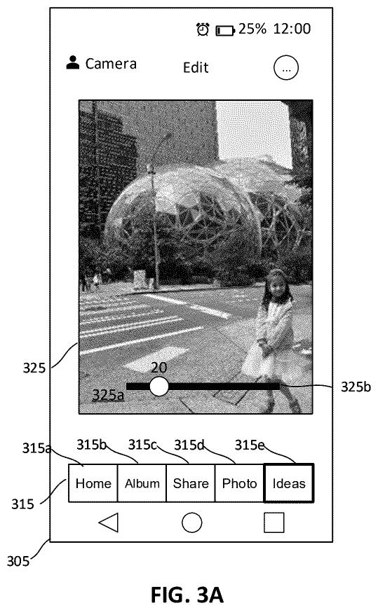

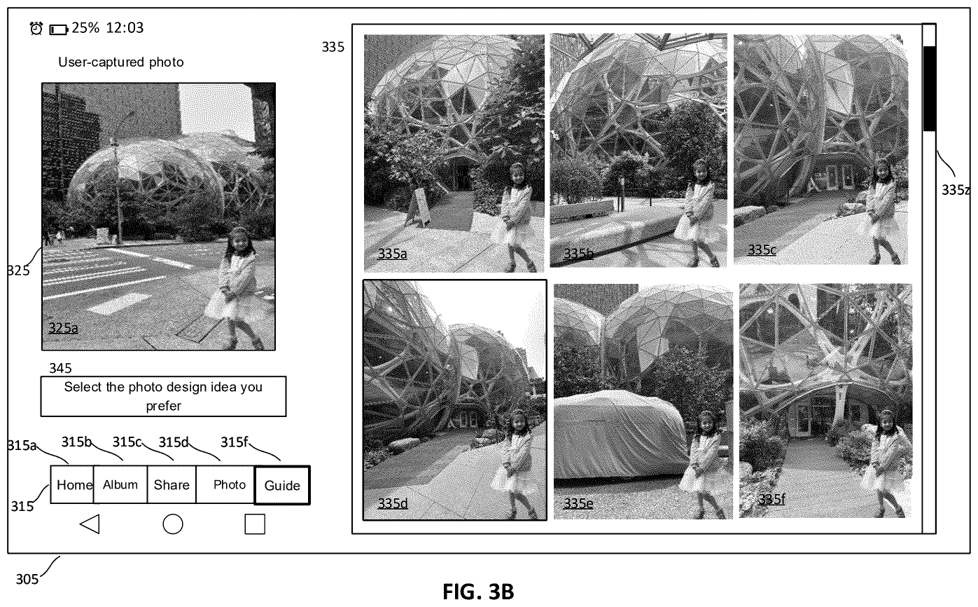

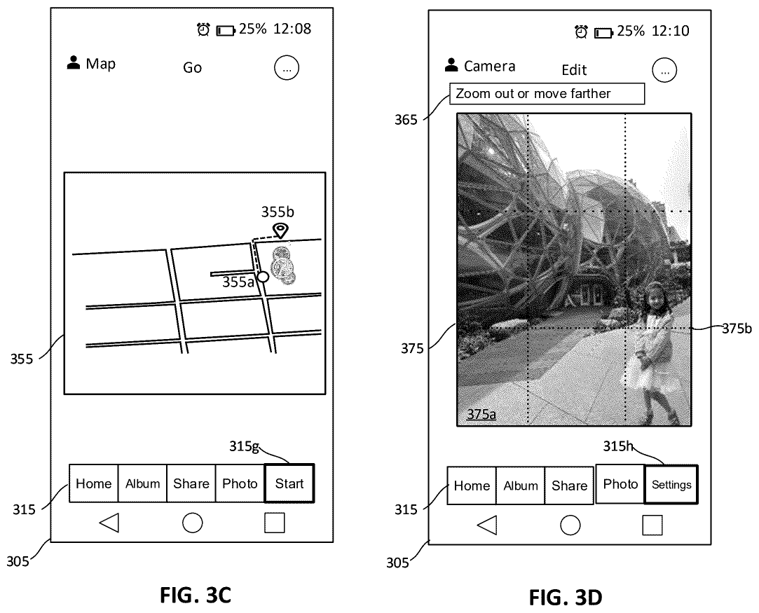

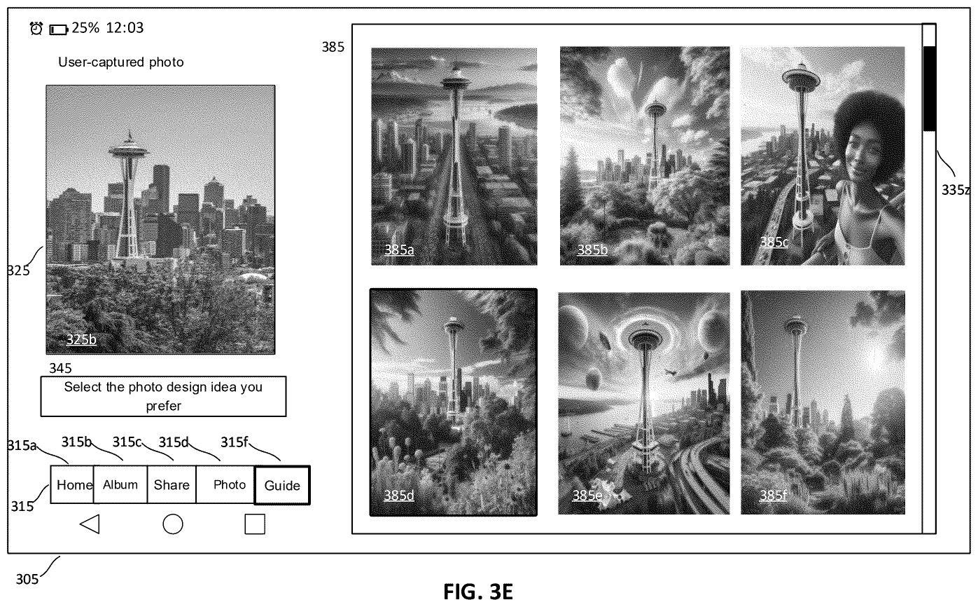

The native application 114 implements a user interface 305 shown in FIGS. 3A-3E in some implementations. In other implementations, the browser application 112 is used for accessing and viewing web-based content provided by the application services platform 110. In such implementations, the application services platform 110 utilizes one or more web applications, such as the browser application 112, that enables users to capture, view, and/or modify photos using, for example, a camera application. The browser application 112 implements the user interface 305 shown in FIGS. 3A-3E in some implementations. The application services platform 110 supports both the native application 114 and the browser application 112 in some implementations, and the users may choose which approach best suits their needs.

The application services platform 110 includes a request processing unit 122, a prompt construction unit 124, AI model(s) 126 (e.g., machine learning (ML) model(s), generative model(s), and the like), a user database 128, an image processing unit 130, a data storage 140, and moderation services (not shown).

At a photo design idea generation stage, the request processing unit 122 is configured to receive requests from the native application 114 and/or the browser application 112 of the client device 105. The requests may include but are not limited to requests to create, view, and/or modify various types of photo design ideas and/or sending prompts to AI model(s) 126 (e.g., a generative model 126a) to generate photo design ideas according to the techniques provided herein.

The photo design idea generation and implementation pipeline leverages the advanced capabilities of AI models (e.g., machine learning models, generative models, and the like) to generate and implement photo design ideas. This pipeline is designed to generate photo design ideas based on a user-captured photo.

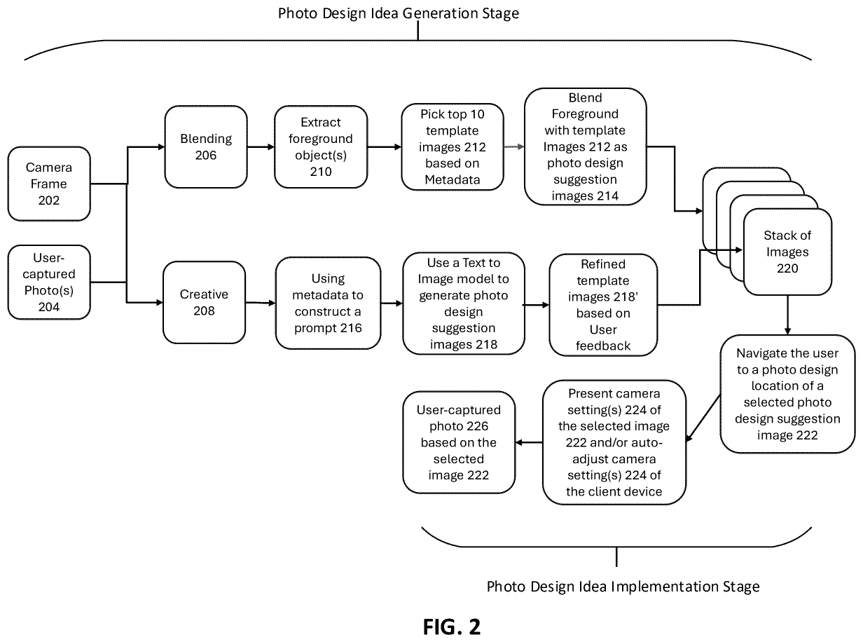

FIG. 2 is a conceptual diagram of a photo design idea generation and implementation pipeline of the system of FIG. 1 according to principles described herein. In FIG. 2, a user uses a viewfinder of the client device 105 to frame shot(s) in step 202 and captures photo(s) 204.

The request processing unit 122 receives user-captured photo(s) 204 and forwards them to the image processing unit 130 for blending processing 206, and/or to the prompt construction unit 124 to for creative processing 208 to generate photo design suggestion images for a user-captured photo. The blending processing 206 and the creative processing 208 can be deployed independently or concurrently. In one embodiment, the image processing unit 130 applies machine learning model(s) (e.g., saliency detection, object recognition and scene understanding, aesthetic considerations, and the like) to extract foreground object(s) 210 (e.g., person, people, or animal) from the user-captured photo(s) 204. For example, the image processing unit 130 deploys an image blurring function/unit that identifies foreground versus background, and then blurs the background. The image processing unit 130 can then extract/separate the foreground versus the background in the photo/image.

The image processing unit 130 retrieves template images 212 locally from the client device 105 or from the cloud, and selects a predetermined number (e.g., ten) of template images 212 there from based on a similarity of metadata (e.g., locations, time points, image tags, and the like) of the retrieved photos to the metadata of the user-captured photo(s) 204. For example, the image processing unit 130 can map a location of the user-captured photo(s) 204 to a popular landmark, then fetch template images form the cloud based on the popular landmark. As another example, the image processing unit 130 can retrieve the template images 212 from public data using an image search engine based on the following metadata of images: a GPS location, a time, captured Image characteristics (e.g., faces detected in the photos, salient objects in the photos, similar photos to the user-captured photo 204, and the like), and image tags generated from the photos by a content management system (CMS) platform. As yet another example, the image processing unit 130 can retrieve the template images 212 from the user's own photos library which meets the following criteria: without objects in foreground, recently taken, and with GPS location relevant to the context.

The image processing unit 130 then applied machine learning model(s) (e.g., image inpainting) to blend the foreground object(s) 210 into each of the template images 212 as a first set photo design suggestion images 214.

When a template image (e.g., one of the template images 212) has no foreground object(s), the image processing unit 130 can directly insert the foreground object(s) 210 into the template image. When a template image has foreground object(s), the image processing unit 130 removes the existing foreground object(s) therefrom, and seamlessly blends in the foreground object(s) 210.

Machine learning algorithms can create a more natural and seamless transition between the object(s) and the background images, minimizing artifacts like ghosting or color inconsistencies. Such image blending based on machine learning can go beyond simple techniques like averaging pixels. For example, techniques like Mask R-CNN can identify objects or specific regions in an image. This allows for precise selection of the area to be blended into another image. GPT-4o is an example powerful multimodal model which can be used, yet it currently does not have specific functionalities for inpainting or image blending. GPT-4o leans more towards text-to-image generation, rather than image editing tasks like inpainting or blending. While GPT-4o can handle some visual inputs and outputs. dedicated image editing models are better suited for inpainting and blending tasks. For inpainting or blending tasks, the photo design idea generation and implementation pipeline can use GPT-4o to generate creative text descriptions that guide other image editing tools.

Alternatively or concurrently, the prompt construction unit 124 generates a text prompt 216 (see Table 1) based on a template prompt and the metadata of the user-captured photo(s) 204 (e.g., location: Space Needle, season: Summer, time of the day: DAY, object: Trees), and then inputs the text prompt 216 to the generative model 126a (e.g., DALLE-3) to generate a second set of photo design suggestion images 218. The image tags are not organized in a strict hierarchy yet form the basis for generating a human-readable description of the photo/image content in complete sentence(s) a part of the text prompt 216. For ambiguous or uncommon image tags, the prompt construction unit 124 and/or the generative model 126a can clarify their meaning within the image context.

TABLE 1

Assume you are Image Generator
Important conditions to consider for Image Generation
Image has to look as natural as possible.
Image should be related to the real world photos.
Image generated should be high quality.
Image Metadata Information
Location or popular place Space Needle
Generated Image should be in Summer
Generated image should be DAY
Generated image should contain Trees
Using the above information Generate top 10 images

The generative model 126a can be a large generative model residing in the cloud, or a small generative model residing in the client device 105. While complex generative models still require significant processing power often found in the cloud, there are some examples of smaller generative models running offline on smartphones for object recognition and auto-photoshoot-settings, text-based generation (e.g., reply messages, text summaries), simple image editing (e.g., background noise reduction, basic style transfer, personalized/custom experiences (e.g., offline voice assistants with personality), and the like. The generative model 126a can be a text-to-image model, a language model, a diffusion model, a vision model, or a multimodal model. The two sets of photo design suggestion images 214, 218 can be combined into a stack of images 220.

In addition to location, time of capture, and image tags, the metadata can include photo details (e.g., title, author/creator, subject, keywords, and the like), photo creation and history (e.g., the date the photo was created, the last modified date and time, the total editing time spent on the photo, comments and track changes, custom properties defined by users, template information, etc.), and the like.

Many content management system (CMS) platforms (e.g., Azure Vision service) offer tagging content, including images, with keywords to facilitate searching and organization. A CMS platform can offer image tagging functionality through an image analyzing API. When a user provides an image URL or uploads the image itself, the API analyzes the visual content. Based on the analysis, the API returns a list of “content tags.” These tags represent objects, living beings, scenery, actions, and the like identified in the image.

Each CMS platform may have its own approach to image tagging, and image tags vary greatly depending on a specific image. Example image tags include generic tags describing the overall content of the image (e.g., “landscape,” “portrait,” “product,” “team photo,” “infographic,” etc.), object tags of specific objects depicted in the image (e.g., “car,” “house,” “dog,” “tree,” “furniture,” etc.), people tags including names, roles (e.g., “CEO,” “customer”), or their relationship to the content (e.g., “speaker,” “attendee”), location tags (e.g., “city,” “country,” or points of interest such as landmarks), event tags (e.g., event name, date, or location), project tags, and the like.

For video shooting ideas, video metadata can include the basic information and actors, directors, location filming (e.g., geotags), non-human characters in the video (e.g., for animation or gaming content), file format and size (e.g., MP4, AVI), video and audio codecs, resolution and frame rate, copyright and licensing, ratings and restrictions, chapter markers, and the like.

In one embodiment, the photo design idea generation and implementation pipeline further provide prompt refinement through at least another generative model call, such as calling the text-to-image model based on user feedback data sent via a feedback loop (e.g., a quality prediction model, and/or a reflection loop based on a confidence threshold).

In one embodiment, the meta prompt in Table I can be a self-improving agent that can modify its own instructions based on its reflections on user interactions, such as a user selection of a thumbs-up tab, a thumbs-down tab, a neutral tab, or a generating-more-image tab, a textual input, or the like, regarding the collage image output. In another embodiment, a DALL-E prompt template can include instructions that guides the AI on how to improve its own instructions based on user positive, neutral, or negative feedback on the second set of photo design suggestion images 218, such as a user selection of a thumbs-up tab, a thumbs-down tab, a neutral tab, or a generating-more-image tab, a textual input, or the like, regarding the collage image output. The pipeline can then create another second set of photo design suggestion images 218′ based on the refined meta prompt(s), and serve the other photo design suggestion images 218′ to the user.

At a photo design idea implementation stage, the photo design idea generation and implementation pipeline navigates the user to a location of a selected photo design suggestion image 222. Additionally, the pipeline causes a presentation of camera setting(s) 224 of the selected image 222 on the client device 105, so the user can manually adjust camera setting(s) of the client device 105 to be close to the camera setting(s) 224 of the selected image 222. Alternatively, the pipeline automatically adjusts the camera setting(s) of the client device 105 as the camera setting(s) 224 of the selected image 222. The user can then capture a photo 226 resembling the selected image 222.

In some implementations, each generative model call needs to pass a responsible AI test. In one embodiment, a responsible AI test is a comprehensive evaluation process that ensures a generative model adheres to ethical principles and operates safely and fairly in the real world. In another embodiment, the test not only checks if the generative model performs its intended task accurately, but also assesses its potential for harm and mitigating negative impacts.

In some implementations, the photo design idea generation and implementation pipeline makes photos captured by users editable, such as adding textual content in the user-captured photo 226 based on a photo design suggestion image. For instance, after the user-captured photo 226 is captured, the photos application can query the user for more user intent details, such as purpose(s), usage(s), and the like of the user-captured photo 226, and then add more content to the user-captured photo 226 based on a photo design suggestion image.

In another embodiment, the prompt construction unit 124 can use user data from various user data source(s) to generate information relating to the purpose(s), the usage(s), and the like of the user-captured photo 226 captured by the user based on a photo design suggestion image. For instance, user activity data can be digitized and stored in the user database 128 for extracting/inferring the purpose(s), the usage(s), and the like of the user-captured photo 226. The user data source(s) can be online/offline databases (e.g., emails, social media posts, and the like), documents, articles, books, presentation content, and/or other types of content containing user activity information.

In one embodiment, in response to the user-captured photo 204 and/or a user query, the photo design idea generation and implementation pipeline retrieves user data from the user database 128 based on an indication identifying the user. The indication may be a user identifier (e.g., a username, an email address, and the like), and/or other identifier associated with the user that the application services platform 110 can use to identify the user and/or add/apply user-related metadata in the photo design idea generation and implementation pipeline. The user data can include a username, a user organization, a user preferred collage style (e.g., grid, mosaic, shaped, vintage, pop art, surreal, abstract, themed, and the like), and the like. Additionally, the prompt construction unit 124 may retrieve the user information from the user database 128 to add to the prompt to a generative model to generate the second set of photo design suggestion images 218, that is to be selected for capturing the user-captured photo 226.

In one embodiment, the generative model is a text-to-image model that generates visual content (e.g., image, video, and the like) based on metadata of a user-captured photo (e.g., the user-captured photo 204). For instance, the generative model 126a may be DALL-E, CLIP, Vision Transformer (ViT), Megatron-Turing NLG, Imagen, GauGAN2, VQGAN+CLIP, SDXL Turbo, Stable Diffusion XL, Stable Diffusion Waifu Diffusion, Realistic Vision, MeinaMix, Anything V3, DreamShaper, Protogen, Elldreths Retro Mix, Modelshoot, or the like. In some implementations, the system selects a text-to-image model based on factors such as open source, photorealistic, creative control, computational requirements, case of use, licensing, and the like. The less sophisticated a text-to-image model is, the more prompt engineering and/or additional tools/models may be required to provide the same quality image outputs. In one embodiment, the generative model is a large multimodal model (LMM), such as Imagen, CLIP (Contrastive Language-Image Pre-Training), FLAN-T5, Flamingo, NuMesh, Gato, and the like.

In one embodiment, the metadata of the template images 212 and/or the user-captured images 204, 226 are saved in a visual content library 142 as user preferred photo data to individualize the photo design idea generation for that user in the future. Other implementations may utilize other machine learning models and/or other generative models to generate photo design ideas based on considerations of open source, photorealistic, creative control, computational requirements, case of use, licensing, and the like. The AI model(s) 126 may be included as part of the application services platform 110 or they may be external models that are called by the application services platform 110. In implementations where other models in addition to the AI model(s) 126 are utilized, those models may be included as part of the application services platform 110 or they may be external models that are called by the application services platform 110.

The request processing unit 122 coordinates communication and exchange of data among components of the application services platform 110 as discussed in the examples which follow. The request processing unit 122 receives user input(s) (e.g., the user-captured photo(s) 204) to generate photo design ideas via the native application 114 or the browser application 112.

The prompt construction unit 124 may reformat or otherwise standardize any information to be included in the prompt to a standardized format that is recognized by the AI model(s) 126. The AI model(s) 126 is trained using training data in this standardized format, in some implementations, and utilizing this format for the prompts provided to the AI model(s) 126 may improve the output quality provided by the AI model(s) 126.

In some implementations, when the user data (e.g., user activity data, preferences, etc.) from the user database 128 is already in the format directly processible by the AI model(s) 126, the prompt construction unit 124 does not need to convert the user data. In other implementations, when the user data is not in the format directly processible by the AI model(s) 126, the prompt construction unit 124 converts the user data to the format directly processible by the AI model(s) 126. Some common standardized formats recognized by a language model include plain text, HTML, JSON, XML, and the like. In one embodiment, the system converts user data into JSON, which is a lightweight and efficient data-interchange format.

The application services platform 110 complies with privacy guidelines and regulations that apply to the usage of the user data included in the user database 128 to ensure that users have control over how the application services platform 110 utilizes their data.

The visual content library 142, request, prompts and responses 144, extracted/inferred user data 146 (e.g., user activities, preferences, feedback, or the like), and other asset data 148 are stored in the data storage 140. The visual content library 142 can store photo metadata, foreground objects, background images, photo design ideas, and the like. The extracted/inferred user data 146 (e.g., activities, preferences, feedback, and the like) is tentatively linked with a user ID during a user session and saved in a cache. After the user session, extracted/inferred user data 146 is de-linked from the user ID as metadata of the user-captured photos, and the resulted photo design ideas are saved in the visual content library 142. In addition, the extracted/inferred user data 146 linked with the user ID is saved back to the user database 128.

The data storage 140 can be physical and/or virtual, depending on the entity's needs and IT infrastructure. Examples of physical user data storage systems include network-attached storage (NAS), storage area network (SAN), direct-attached storage (DAS), tape libraries, hybrid storage arrays, object storage, and the like. Examples of virtual user data storage systems include virtual SAN (vSAN), software-defined storage (SDS), cloud storage, hyper-converged Infrastructure (HCI), network virtualization and software-defined networking (SDN), container storage, and the like.

FIGS. 3A-3E are diagrams of an example user interface of an AI-based photo design idea generation and implementation application that implements the techniques described herein. The example user interface shown in FIGS. 3A-3E is a user interface of an AI-based photo design idea generation and implementation application, such as but not limited to Windows Camera®, or Microsoft Photos®. However, the techniques discussed herein for AI-based photo design idea generation and implementation are not limited to use in an AI-based photography applications and may be used to generate visual content for other types of applications including but not limited to storage management applications, presentation applications, website authoring applications, collaboration platforms, communications platforms, social media applications, e-commerce applications, and/or other types of applications in which users create, view, and/or modify various types of photo design ideas. Such AI-based photo design idea generation and implementations can be features built-in a photos application, a camera application, or a storage management application, a mini application in an AI-based design platform, a stand-alone application, or a plug-in of any application on the client device 105, such as the browser application 112, the native application 114, and the like. For example, the photo design idea generation and implementation pipeline can work on the web or within a cloud storage management application (e.g., Microsoft OneDrive®). The pipeline can be integrated into the Microsoft Photos® or could work within a browser (e.g., Windows® Edge®). The pipeline can also work within a social media website/application (e.g., Facebook®, Instagram®).

FIG. 3A shows an example of the user interface 305 of an AI-based photo design idea generation and implementation application in which the user is interacting with AI model(s) to generate photo design ideas. The user interface 305 includes a control pane 315, and an image pane 325. The user interface 305 may be implemented by the native application 114 and/or the browser application 112.

In some implementations, the control pane 315 includes a Home button 315a, an Album button 315b, a Share button 315c, a Photo button 315d, and an idea button 315c. In the example shown in FIG. 3A, the image pane 325 shows a user-captured photo 325a (e.g., a little girl standing across the street from the Amazon's Spheres in Seattle, Washington, USA). The image pane 325 shows an image blurring scrollbar 325b that identifies foreground and then blurs the background as the user moves the indicator on the image blurring scrollbar 325b. The image processing unit 130 then can extract/separate a foreground object (e.g., a little girl) in the user-captured photo 325a.

The Idea button 315e can be selected to provide AI-based photo design idea generation based on the user-captured photo 325a as discussed. In some implementations, the image pane 325 provides a chatbot in which the user can enter prompts in the AI-based photo design idea generation and implementation application for generating photo design ideas with desired style(s) and topic(s).

Alternatively, the AI-based photo design idea generation and implementation application can invite the user to select a user-captured photo from an album by selecting the Album button 315b, for automatically generating photo design ideas based on the user-captured photo 325a as discussed in the various embodiments.

FIG. 3B continues from FIG. 3A upon a selection of the Idea button 315e. In this example, the image pane 325 on the left side shows the user-captured photo 325a, while another image pane 335 on the right side shows a plurality of photo design idea images 335a-335f generated via the blending processing 206. The user can move a scrollbar 335z to see additional photo design ideas. For instance, the photo design idea images 335a-335f were created from inserting/placing the little girl into some template images selected based on metadata. Below the image pane 325, there is a user instruction 345 “Select the photo design idea you prefer.”

Upon a user selection of the photo design idea image 335d from the image pane 335 and a Guide button 315f from the control pane 315 in FIG. 3B, a map application is triggered to navigate the user to a location of the photo design idea image 335d as shown in FIG. 3C. The user interface 305 in FIG. 3C includes the control pane 315 and a Map pane 355. The Map pane 355 shows a top view of the Amazon's Spheres, a current user location 355a, the location 355b of the photo design idea image 335d, and a route from the current location 355a to the location 355b. Upon a user selection of a Start button 315g of the control pane 315 in FIG. 3C, the navigation starts.

When the user arrives at the location 355b of the photo design idea image 335d, the AI-based photo design idea generation and implementation application can automatically switch on the camera application and/or display the photoshoot settings of the photo design idea image 335d as listed in Table 2.

TABLE 2
Camera Mode: Photo (not video)
Exposure/Focus: Auto
Night Mode: Auto (Night mode automatically activates in low light
conditions)
Pro: Off (This is a higher quality image format but uses more storage
space)
Live Photos: On (Captures a short video clip with the still image)
HDR (High Dynamic Range): On (Improves detail in highlights and
shadows)
Lens Correction: On (Automatically corrects for distortion)
Grid Mode: On (Displays a grid overlay to help with composition)

When detecting one or more current camera settings are different from the photoshoot settings of the photo design idea image 335d, the AI-based photo design idea generation and implementation application can use an AI model to generate and display photoshoot setting suggestion in FIG. 3D. For example, FIG. 3D shown a photo design suggestion 365: “Zoom out or move farther.”

Upon a user selection of a Settings button 315h of the control pane 315 in FIG. 3D, the AI-based photo design idea generation and implementation application can execute the photoshoot settings of the photo design idea image 335d on the client device 105 for the user. Concurrently or alternatively, the AI-based photo design idea generation and implementation application can automatically execute the photoshoot settings of the photo design idea image 335d for the user. For instance, the Grid Mode is turned on as grid lines 375b over a live camera view 375a of the client device 105. The user then takes a photo at the location and based on the settings of the photo design idea image 335d.

FIG. 3E depicts the embodiment of generating photo design ideas via the creative processing 208 using a generative model. In this example, the user captured an image near the Space Needle in Seattle, Washington. Upon a selection of the Idea button 315e, the image pane 325 on the left side shows the user-captured photo 325a, while another image pane 385 on the right side shows a plurality of photo design idea images 385a-385f generated by a generative model based on the meta data of the captured photo 325b. The user can move a scrollbar 335z to see additional photo design ideas. For instance, the photo design idea images 385a-385f were created by DALLE-3 based on metadata of the captured photo 325b, e.g., location: Space Needle, season: Summer, time of the day: DAY, object: Trees. Below the image pane 325, there is a user instruction 345 “Select the photo design idea you prefer.”

Upon a user selection of the photo design idea image 385d from the image pane 385 and a Guide button 315f from the control pane 315 in FIG. 3B, a map application is triggered to online search an image resembling the photo design idea image 385d, retrieve the location data of the retrieved image, and to navigate the user to a location of the retrieved image similarly to what is shown in FIG. 3C.

In some implementations, the photo design idea generation and implementation pipeline provides a feedback loop by augmenting thumbs up and thumbs down selections for each user-captured photo based on a photo design suggestion image. If the user dislikes a photo user-captured based on a photo design suggestion image, the pipeline can ask why and use the user feedback data to improve the AI model(s) 126. A thumbs down click could also prompt the user to indicate whether the user-captured photo based on a photo design suggestion image was too bright, too dark, too big, too small, or was at the wrong location, or the like.

The system can instruct the generative model 126a to generate a single-shot prompt (i.e., including a single example or instruction to guide the generative model's response) or a multi-shot prompt (i.e., including multiple examples or instructions to give the model more context and improve its understanding of the task) for generating the user-captured photo based on a photo design suggestion image.

In some implementations, the application services platform 110 includes moderation services that analyze user prompt(s), content generated by the AI model(s) 126, and/or the user data obtained from the user database 128, to ensure that potentially objectionable or offensive content is not generated or utilized by the application services platform 110.

If potentially objectionable or offensive content is detected in the user data obtained from the user database 128, the moderation services provides a blocked content notification to the client device 105 indicating that the prompt(s), the user data is blocked from forming the meta prompt. In some implementations, the request processing unit 122 discards any user data that includes potentially objectionable or offensive content and passes any remaining content that has not been discarded by the request processing unit 122 to be provided as an input to the prompt construction unit 124. In other implementations, the prompt construction unit 124 discards any content that includes potentially objectionable or offensive content and passes any remaining content that has not been discarded to the AI model(s) 126 as an input.

In one embodiment, the prompt construction unit 124 submits the user prompt(s), and/or the meta prompt to the moderation services to ensure that the prompt does not include any potentially objectionable or offensive content. The prompt construction unit 124 halts the processing of the meta prompt in response to the moderation services determining that the user data and/or prompt(s) includes potentially objectionable or offensive content.

The image processing unit 130 may include an OCR tool to identify text element(s) from a user-uploaded image, and use the text element(s) as the metadata of the user captured photo 204. In some implementations, the OCR tool stores the text clement(s) in editable characters for potential use. The image processing unit 130 can access the user database 128 for user input image data for pre-processing, such as identifying textual elements. The user database 128 can be implemented on the application services platform 110 in some implementations. In other implementations, at least a portion of the user database 128 is implemented on an external server that is accessible by the prompt construction unit 124.

As mentioned above, the application services platform 110 complies with privacy guidelines and regulations that apply to the usage of the user data included in the user database 128 to ensure that users have control over how the application services platform 110 utilizes their data. The user is provided with an opportunity to opt into the application services platform 110 to allow the application services platform 110 to access the user data and enable the AI model(s) 126 to generate visual content according to the user's desired style/topic. In some implementations, the first time that an application, such as the native application 114 or the browser application 112 presents an AI assistant to the user, the user is presented with a message that indicates that the user may opt into allowing the application services platform 110 to access user data included in the user database 128 to support the AI-based photo design idea generation functionality. The user may opt into allowing the application services platform 110 to access all or a subset of user data included in the user database 128. Furthermore, the user may modify their opt-in status at any time by accessing their user data and selectively opting into or opting out of allowing the application services platform 110 from accessing and utilizing user data from the user database 128 as a whole or individually.

Referring back to the moderation services, the moderation services generates a blocked content notification in response to determining that the user prompt(s), and/or the meta prompt includes potentially objectionable or offensive content, and the notification is provided to the native application 114 or the browser application 112 so that the notification can be presented to the user on the client device 105. For instance, the user may attempt to revise and resubmit the user prompt(s). As another example, the system may generate another meta prompt after removing task data associated with the potentially objectionable or offensive content.

The prompt construction unit 124 can halt the processing of the photo design suggestion image(s) in response to the moderation services determining that the graphic design includes potentially objectionable or offensive content. The moderation services generates a blocked content notification in response to determining that the photo design suggestion image(s) includes potentially objectionable or offensive content, and the notification is provided to the prompt construction unit 124. The prompt construction unit 124 may attempt to revise and resubmit the integrated text prompt. If the moderation services does not identify any issues with the photo design suggestion image(s), the prompt construction unit 124 provides the photo design suggestion image(s) to the request processing unit 122. The request processing unit 122 provides the photo design suggestion image(s) to the native application 114 or the browser application 112 depending upon which application was the source of the user-uploaded images.

The moderation services can be implemented by a machine learning model trained to analyze the content of these various inputs and/or outputs to perform a semantic analysis on the content to predict whether the content includes potentially objectionable or offensive content. The specific checks performed by the moderation services may vary from implementation to implementation.

In some implementations, the moderation services generates a blocked content notification, which is provided to the client device 105. The native application 114 or the browser application 112 receives the notification and presents a message on a user interface of the application that the user prompt received by the request processing unit 122 could not be processed. The user interface provides information indicating why the blocked content notification was issued in some implementations. The user may attempt to refine a prompt to remove the potentially offensive content. A technical benefit of this approach is that the moderation services provides safeguards against both user-created and model-created content to ensure that prohibited offensive or potentially offensive content is not presented to the user in the native application 114 or the browser application 112.

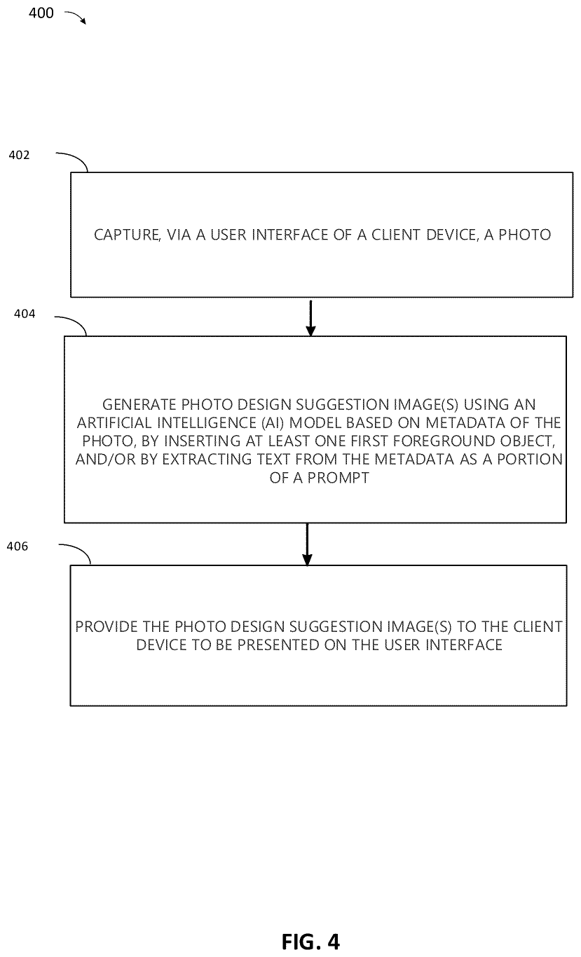

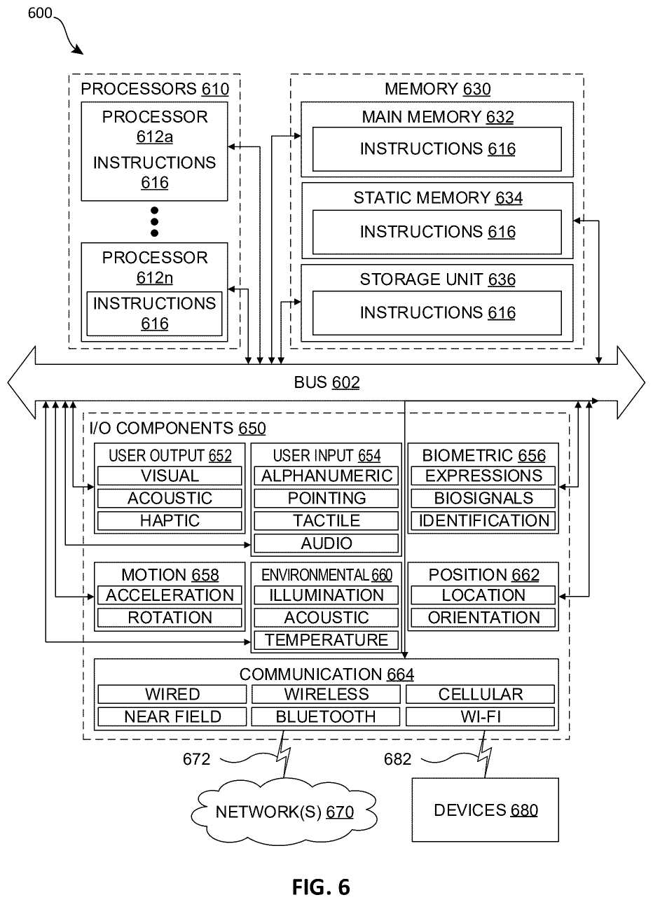

FIG. 4 depicts a flow chart of an example process 400 for AI-based photo design idea generation and implementation according to the techniques disclosed herein. The process 400 can be implemented by the application services platform 110 or its components shown in the preceding examples. The process 400 may be implemented in, for instance, the example processor and memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, the request processing unit 122 captures, via a user interface (e.g., the user interface 305) of a client device (e.g., the client device 105), a photo (e.g., the user-captured photo(s) 204 in FIG. 2, or the user-captured photo 325a in FIG. 3A and on the left side of FIG. 3B).

In step 404, the image processing unit 130 generates one or more photo design suggestion images (e.g., the photo design idea images 335a-335f on the right side of FIG. 3B) using an artificial intelligence (AI) model (e.g., the AI model(s) 126) based on metadata of the photo, by inserting at least one first foreground object, extracting text from the metadata as a portion of a prompt, or a combination thereof. For instance, the metadata includes a location, a time, and one or more image tags (e.g., “landscape,” “portrait,” “product,” “team photo,” “infographic,” “car,” “house,” “dog,” “tree,” “furniture,” “CEO,” “customer,” “speaker,” “attendee,” “Amazon's Spheres,” “city,” “country,” and the like. In one embodiment, the image processing unit 130 generates at the client device the one or more image tags (e.g., tagged by the camera application, or entered by the user). In another embodiment, the image processing unit 130 receives the one or more image tags generated by a content management system.

According to blending processing (e.g., the blending processing 206 in FIG. 2), the image processing unit 130 generates one or more photo design suggestion images (e.g., the first set photo design suggestion images 214) by selecting, based on the metadata of the photo, one or more other photos captured by the client device (e.g., last year visit to the Amazon's Spheres with the user's colleagues) or by one or more other client devices (e.g., cloud-sourced photos taken near or at the Amazon's Spheres, including a celebrity standing on Amazon's Spheres), and applying the AI model (e.g., machine learning model(s)/algorithm(s)) to extract at least one second foreground object (e.g., the celebrity) from each of the one or more other photos, to extract the at least one first foreground object (e.g., the little girl) from the photo, and to replace the at least one second foreground object (e.g., the celebrity) with the at least one first foreground object (e.g., the little girl) in each of the one or more other photos as the one or more photo design suggestion images. Optionally, the image processing unit 130 refines each of the one or more other photos replaced with the at least one first foreground object using an image inpainting model (so that the first foreground object appearing more nature in the other photos), and uses the refined one or more other photos as the one or more photo design suggestion images.

In another embodiment of the blending processing, the image processing unit 130 generates one or more photo design suggestion images by selecting the one or more other photos based on the metadata of the photo; determining at least one of the one or more other photos has no foreground object (e.g., a photo of the Amazon's Spheres without human objects); extracting the at least one first foreground object (e.g., the little girl) from the photo; and inserting the at least one first foreground object (e.g., the little girl) into the at least one other photo as one of the photo design suggestion images. Optionally, the image processing unit 130 refines the at least one other photo inserted with the at least one first foreground object using an image inpainting model (so that the first foreground object appearing more nature in the other photo), and uses the refined at least one other photo as the one of the photo design suggestion images.

According to creative processing (e.g., the creative processing 208 in FIG. 2), the AI model is a generative model, and the prompt construction unit 124 generates the one or more photo design suggestion images (e.g., the second set of photo design suggestion images 218) by constructing a first prompt by appending the metadata of the photo to a first instruction string, and providing as an input the first prompt to the generative model and receiving as an output the one or more photo design suggestion images from the generative model. The first instruction string includes instructions to the generative model to extract the text from the metadata of the photo, to generate the one or more photo design suggestion images based on the text. By way of example, the generative model is a text-to-image model, a vision model, or a multimodal model.

In another embodiment of the creative processing, the first instruction string is further appended with the photo, and the first instruction string further includes instructions to extract the at least one first foreground object from the photo, to insert the at least one first foreground object into the one or more photo design suggestion images, and to refine each of the one or more photo design suggestion images inserted with the at least one first foreground object using an image inpainting model.

In yet another embodiment of the creative processing, the first instruction string is further appended with the photo, and one or more other photos captured by the client device or one or more other client devices, and the first instruction string further includes instructions to select the one or more other photos based on the metadata of the photo, to extract at least one second foreground object for each of the one or more other photos, to extract the at least one first foreground object from the photo, to replace the at least one second foreground object with the at least one first foreground object the images in each of the one or more other photos, and to refine each of the one or more other photos replaced with the at least one first foreground object using an image inpainting model as the one or more photo design suggestion images (e.g., the second set of photo design suggestion images 218′).

In step 406, the request processing unit 122 provides the one or more photo design suggestion images to display on the user interface of the client device. In one embodiment, the request processing unit 122 receives, via the user interface of the client device, a user selection of one of the one or more photo design suggestion images, generates at the client device navigation instructions (e.g., the route from the current location 355a to the location 355b in FIG. 3C) to a location (e.g., the location 355b in FIG. 3C) associated with the selected photo design suggestion image (e.g., the photo design idea image 335d in FIG. 3B), and provides the navigation instructions to display on the user interface of the client device. In one embodiment, the request processing unit 122 stores the metadata of the photo and the one or more photo design suggestion images as templates in a photo template library (e.g., the visual content library 142).

In some implementations, the request processing unit 122 receives at least one user feedback on the photo design suggestion image(s) (e.g., the photo design idea images 335a-335f in FIG. 3B) and/or the user-captured photo 226 user-captured based on a photo design suggestion image via the user interface (e.g., the user interface 305). For example, the user feedback is collected via a user selection of at least one of a thumbs-up tab, a thumbs-down tab, a neutral tab, or a generating-more-image tab, a textual input, or the like. The prompt construction unit 124 can construct a meta prompt by appending the feedback and the photo design suggestion image(s) and/or the user-captured photo 226 to another instruction string comprising instructions to the generative model (e.g., the generative model 126a) to generate another textual description combining the feedback (e.g., a thumb-down tab) and the photo design suggestion image(s) and/or the user-captured photo 226 as a new meta prompt, and to input the new meta prompt into the generative model 126a to refine the prompt. The refined prompt is then sent back to the generative model 126a to generate another the photo design suggestion image(s) for user selection to capture another photo.

The photo design idea generation and implementation pipeline only requires a user to capture a photo to automatically generate photo design suggestion images thus simplifying the photography process for the users. The photo design suggestion images promote intentional photography, and a specific goal moves the user beyond just point-and-shoot photography. In addition, the photo design suggestion images sparks creativity, and help the user see different perspectives. As such, the user is more likely to capture interesting and creative photos. By automating the AI-based photo design idea generation process, the pipeline eliminates the user having to manually select template images.

In addition, the pipeline extracts foreground object(s) form a user-captured photo, and then blends the foreground object(s) into the template images as photo design suggestion images. This helps the user to visualize the foreground object(s) in the template images, and makes photography more engaging.

Moreover, the pipeline assists the user to a photo resembling a selected photo design suggestion image by navigating the user to the relevant location, suggesting and/or automatically adjusting the relevant photoshoot camera settings. These significantly increase the user's chances of capturing a desired photo. Also, the displayed photoshoot camera settings can be applied by the user and gradually improve the user's photography skills.

The pipeline can apply the AI-based photo design idea generation to a range of visual content types, including images, videos, or the like, which can be instrumental in photo creation, thereby enhancing the versatility of a design platform.

The request processing unit 122 or the prompt construction unit 124 performs content moderation on the photo design suggestion images before providing the photo design suggestion images to the client device (e.g., the client device 105). After the content moderation, the request processing unit 122 or the prompt construction unit 124 adds meta data of the photo design suggestion images as an additional image template(s) in a visual content library (e.g., the visual content library 142). The metadata includes a location, a time, one or more image tags, and the like.

In some implementations, the photo design idea generation and implementation pipeline can share the user-captured photo 226 immediately, so that the user can celebrate or promote the relevant event (e.g., a college graduation commencement, a new attraction opening, and the like). In other implementations, the pipeline can start a new AI chat to help the user to plan the events by suggesting an action plan with steps. For example, when the user organizes a college graduation party, this would often involve setting a budget, creating a guest list, planning the food and drinks, arranging entertainment, reserving and then decorating the venue, and the like. In other implementations, the pipeline can perform the actions of the event on behalf of the user, such as setting the budget for the college graduation party, reserving the venue, and the like.

Therefore, the photo design idea generation and implementation pipeline provides AI-based photo design idea generation based on a user-captured photo, without user inputs anything else. The pipeline fetches one or more template images from the user of the cloud based on the metadata of the user-captured photo. In addition, the pipeline can generate photo design suggestion images by applying blending and/pr creative processing, and the guide the user to capture a photo based on a selected photo design suggestion image.

There are security and privacy considerations and strategies for using open source generative models with user data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting user data from unauthorized access or exposure.

In an example, the application services platform 110 can store user data separately from generative model training data, to reduce the risk of unintentionally leaking sensitive information during model generation. The application services platform 110 can limit access to generative models and the user data. The application services platform 110 can also implement proper access controls, strong authentication, and authorization mechanisms to ensure that only authorized personnel can interact with the selected model and the user data.

The application services platform 110 can also run the AI model(s) 126 in a secure computing environment. Moreover, the application services platform 110 can employ robust network security, firewalls, and intrusion detection systems to protect against external threats. The application services platform 110 can encrypt the user data and any data in transit. The application services platform 110 can also employ encryption standards for data storage and data transmission to safeguard against data breaches.

Moreover, the application services platform 110 can implement strong security measures around the AI model(s) 126 itself, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data (especially user data) is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of user data and the responsible use of generative models. In addition, the application services platform 110 can stay up-to-date with evolving security threats and best practices that are essential for ongoing data protection.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

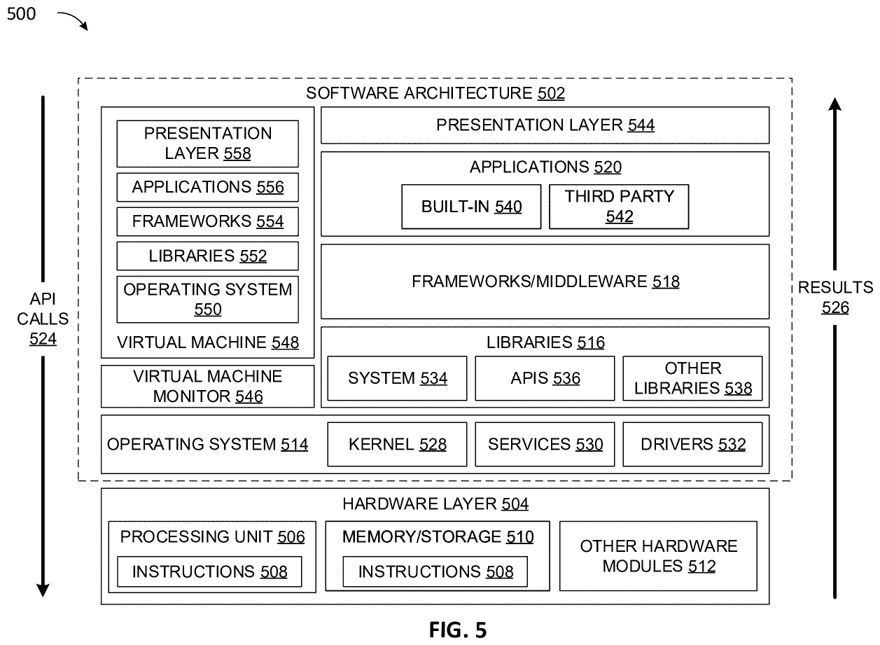

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), a neural processing unit (NPU), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or clement in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and a machine-readable storage medium storing executable instructions which, when executed by the processor, cause the processor alone or in combination with other processors to perform the following operations:
capturing, via a user interface of a client device, a photo;
generating one or more photo design suggestion images using an artificial intelligence (AI) model based on metadata of the photo by inserting at least one first foreground object, extracting text from the metadata as a portion of a prompt, or a combination thereof, wherein the metadata includes a location, a time, and one or more image tags; and
providing the one or more photo design suggestion images to display on the user interface of the client device.

2. The data processing system of claim 1, wherein the machine-readable storage medium further includes instructions configured to cause the processor alone or in combination with other processors to perform at least one of:
generating at the client device the one or more image tags, or
receiving the one or more image tags generated by a content management system.

3. The data processing system of claim 1, wherein generating the one or more photo design suggestion images includes:
selecting, based on the metadata of the photo, one or more other photos captured by the client device or by one or more other client devices;
applying the AI model to extract at least one second foreground object from each of the one or more other photos, to extract the at least one first foreground object from the photo, and to replace the at least one second foreground object with the at least one first foreground object in each of the one or more other photos as the one or more photo design suggestion images, wherein the AI model includes one or more machine learning algorithms.

4. The data processing system of claim 3, wherein the machine-readable storage medium further includes instructions configured to cause the processor alone or in combination with other processors to perform operations of:
refining each of the one or more other photos replaced with the at least one first foreground object using an image inpainting model; and
using the refined one or more other photos as the one or more photo design suggestion images.

5. The data processing system of claim 1, wherein generating the one or more photo design suggestion images includes:
selecting the one or more other photos based on the metadata of the photo;
determining at least one of the one or more other photos has no foreground object;
extracting the at least one first foreground object from the photo; and
inserting the at least one first foreground object into the at least one other photo as one of the photo design suggestion images.

6. The data processing system of claim 5, wherein the machine-readable storage medium further includes instructions configured to cause the processor alone or in combination with other processors to perform operations of:
refining the at least one other photo inserted with the at least one first foreground object using an image inpainting model; and
using the refined at least one other photo as the one of the photo design suggestion images.

7. The data processing system of claim 1, wherein the AI model is a generative model, and generating the one or more photo design suggestion images includes:
constructing, via a prompt construction unit, a first prompt by appending the metadata of the photo to a first instruction string, the first instruction string including instructions to the generative model to extract the text from the metadata of the photo, to generate the one or more photo design suggestion images based on the text; and
providing as an input the first prompt to the generative model and receiving as an output the one or more photo design suggestion images from the generative model.

8. The data processing system of claim 7, wherein the generative model is a text-to-image model, a vision model, or a multimodal model.

9. The data processing system of claim 7, wherein the first instruction string is further appended with the photo, and
wherein the first instruction string further includes instructions to extract the at least one first foreground object from the photo, to insert the at least one first foreground object into the one or more photo design suggestion images, and to refine each of the one or more photo design suggestion images inserted with the at least one first foreground object using an image inpainting model.

10. The data processing system of claim 7, wherein the first instruction string is further appended with the photo, and one or more other photos captured by the client device or one or more other client devices, and
wherein the first instruction string further includes instructions to select the one or more other photos based on the metadata of the photo, to extract at least one second foreground object for each of the one or more other photos, to extract the at least one first foreground object from the photo, to replace the at least one second foreground object with the at least one first foreground object the images in each of the one or more other photos, and to refine each of the one or more other photos replaced with the at least one first foreground object using an image inpainting model as the one or more photo design suggestion images.

11. The data processing system of claim 1, wherein the machine-readable storage medium further includes instructions configured to cause the processor alone or in combination with other processors to perform operations of:
receiving, via the user interface of the client device, a user selection of one of the one or more photo design suggestion images;
generating at the client device navigation instructions to a location associated with the selected photo design suggestion image; and
providing the navigation instructions to display on the user interface of the client device.

12. The data processing system of claim 1, wherein the machine-readable storage medium further includes instructions configured to cause the processor alone or in combination with other processors to perform operations of:
storing the metadata of the photo and the one or more photo design suggestion images as templates in a photo template library.

13. A method comprising:
capturing, via a user interface of a client device, a photo;
generating one or more photo design suggestion images using an artificial intelligence (AI) model based on metadata of the photo by inserting at least one first foreground object, extracting text from the metadata as a portion of a prompt, or a combination thereof, wherein the metadata includes a location, a time, and one or more image tags; and
providing the one or more photo design suggestion images to display on the user interface of the client device.

14. The method of claim 13, further comprising at least one of:
generating at the client device the one or more image tags, or
receiving the one or more image tags generated by a content management system.

15. The method of claim 13, wherein generating the one or more photo design suggestion images includes:
selecting, based on the metadata of the photo, one or more other photos captured by the client device or by one or more other client devices;
applying the AI model to extract at least one second foreground object from each of the one or more other photos, to extract the at least one first foreground object from the photo, and to replace the at least one second foreground object with the at least one first foreground object in each of the one or more other photos as the one or more photo design suggestion images, wherein the AI model includes one or more machine learning algorithms.

16. The method of claim 15, further comprising:
refining each of the one or more other photos replaced with the at least one first foreground object using an image inpainting model; and
using the refined one or more other photos as the one or more photo design suggestion images.

17. A non-transitory computer readable medium on which are stored instructions that, when executed, cause a programmable device to perform functions of:
capturing, via a user interface of a client device, a photo;
generating one or more photo design suggestion images using an artificial intelligence (AI) model based on metadata of the photo by inserting at least one first foreground object, extracting text from the metadata as a portion of a prompt, or a combination thereof, wherein the metadata includes a location, a time, and one or more image tags; and
providing the one or more photo design suggestion images to display on the user interface of the client device.

18. The non-transitory computer readable medium of claim 17, wherein the instructions when executed, further cause the programmable device to perform functions of:
generating at the client device the one or more image tags, or receiving the one or more image tags generated by a content management system.

19. The non-transitory computer readable medium of claim 17, wherein generating the one or more photo design suggestion images includes:
selecting, based on the metadata of the photo, one or more other photos captured by the client device or by one or more other client devices;
applying the AI model to extract at least one second foreground object from each of the one or more other photos, to extract the at least one first foreground object from the photo, and to replace the at least one second foreground object with the at least one first foreground object in each of the one or more other photos as the one or more photo design suggestion images, wherein the AI model includes one or more machine learning algorithms.

20. The non-transitory computer readable medium of claim 19, wherein the instructions when executed, further cause the programmable device to perform functions of:
refining each of the one or more other photos replaced with the at least one first foreground object using an image inpainting model; and
using the refined one or more other photos as the one or more photo design suggestion images.
